(19) United States
(12) Patent Application Publication
(10) Pub. No.: US 2020/0065127 A1
(43) Pub. Date: Feb. 27, 2020

(54) VIRTUALIZED RESOURCE MONITORING SYSTEM

(71) Applicant: GLUESYS, CO, LTD, Anyang-si (KR)

(72) Inventors: Tae Hoon KIM, Yongin-si (KR); Gyeong Hun Kim, Suwon-si (KR); Jae Chun No, Seoul (KR)

(21) Appl. No.: 16/136,308

(22) Filed: Sep. 20, 2018

(30) Foreign Application Priority Data
Aug. 23, 2018 (KR) 10-2018-0098435

(51) Int. Cl. G06F 9/455; G06F 9/50; G06F 16/906; G06F 16/17

(52) U.S. Cl. CPC G06F 9/45558; G06F 9/5077; G06F 2009/45591; G06F 16/1734; G06F 2009/4557; G06F 16/906

(57) ABSTRACT

The present invention relates to a virtualized resource monitoring system which collects system resource-related information and log and can analyze a usage rate of computing resources of a virtual machine. A virtualized resource monitoring system (RV-MON) according to the present invention includes: an RV-MON agent which collects resource information of a plurality of virtualization servers and a plurality of virtual machines through a hypervisor; and an RV-MON service unit which integrates, stores, and aligns the resource information, and provides the resource information to an external module a storage pattern set from a monitoring unit.

### CROSS REFERENCE TO RELATED APPLICATIONS

This application is related to and claims priority from Korea Patent Application No. KR 10-2018-0098435 filed Aug. 23, 2018, which is incorporated herein by reference in its entirety.

### BACKGROUND OF THE INVENTION

### Field of the Invention

The present invention relates to a virtualized resource monitoring system, and more specifically, to a virtualized resource monitoring system which collects system resource related information and log and can analyze a usage rate of computing resources of a virtual machine.

### Description of the Related Art

Conventional monitoring systems have been studied and developed in terms of 1) process and resource management technology from the point of view of a single server platform, 2) multi-node information collection in a virtualization environment configured with clusters, and 3) data collection and management technology for information analysis.

In the process and resource management method from the point of view of a single server platform, there are a task manager and a top program as system monitoring programs installed in a system to monitor an environment of a server. The two system monitoring programs provide usage rates of a CPU, a memory, a disk, and a network, which are important resources of a system, in real time, check a ratio of resources occupied by a process, and can execute a command related to the process. Such system monitoring programs have an advantage of providing various kinds of resource information from an operating server, but it is difficult to efficiently manage a state of a server in a cluster environment since remote server information is not provided (Korean Patent No. 10-1541617).

Virtualization is a core technology of cloud, and a plurality of virtual machines can be operated by a single server connected through clusters. In such environment, the present virtualized monitoring system collects and provides various kinds of resource information of a virtual machine and a server. In a virtualization environment, data collected by a monitoring system can be used to predict a resource usage rate of a virtual machine, and a server can allocate resources optimal for the virtual machine to increase resource efficiency (Korean Laid-Open Patent No. 2016-0105636.

The virtualized monitoring system can provide information necessary to predict a resource usage rate of the virtual machine, but there is a limit. First, the virtualized monitoring system mainly provides real-time resource usage rate information to a user, but does not provide original data including detailed. parameter information of resources collected to calculate a real-time resource usage rate. Accordingly, a user has to predict a future resource usage rate of the virtual machine by using only the past resource usage rate, and it is difficult to raise accuracy in prediction of the resource usage rate with information in a limited range. Second, the virtualized monitoring system does not collect system-related log. In the present resource prediction, the future resource usage rate is predicted on the basis of the resource usage rate collected in real-time. In this case, it is difficult to identify the accurate cause of why resources are short. For this reason, detailed parameter information has to be also provided together, but the most accurate identification method is to check system log related to resources. In the system log, a critical issue generated in each resource is recorded, and such information a very important data to predict an accurate resource usage rate. Third, in the virtualization environment connected through clusters, a monitoring function is not supported. A virtualized monitoring program provides only a monitoring technique based on a single server. In a multi-server environment, virtualization information collected in each server is not integrated and provided. Fourth, only information provided from the monitoring system can be used, and a separate processing system is necessary to process additional information. A user who uses the present monitoring system can collect information only within the range provided by the monitoring system, and cannot reflect information required by the user to the monitoring system.

### SUMMARY OF THE INVENTION

The present invention has been made to solve such a problem, and an object of the present invention is to provide a virtualized resource monitoring system which collects and processes information necessary to predict a resource usage rate of a virtual machine in a virtualization environment including multiple servers.

Another object of the present invention is to provide a virtualized resource monitoring system which collects resource information, parameters, and system log which are original data of a resource usage rate of a virtual machine to analyze relationship among resources and to derive an optimized resource usage rate, and processes information according to user's requirements even without a separate processing system.

A virtualized resource monitoring system (RV-MON) according to the present invention includes: an RV-MON agent which collects resource information of a plurality of virtualization servers and a plurality of virtual machines through a hypervisor; and an RV-MON service unit which integrates, stores, and aligns the resource information, and provides the resource information to an external module, wherein the RV-MON agent includes a virtual resource tracer which collects resource information of virtual machines, a server resource tracer which collects resource information of virtualization servers, and a V-calculator which calculates a resource usage rate on the basis of the information collected from the virtual machines and the virtualization servers, wherein RV-MON service unit includes a database which integrates and stores the information collected in the RV-MON agent, and a management interface which manages the database and the RV-MON agent, and wherein the management interface executes checking a state of the RV-MON agent and changing settings according to a virtualization server information and virtual machine information collection period and a storage pattern set from a monitoring unit, a calculation script to be applied to the V-calculator, and management of a database table.

### BRIEF DESCRIPTION OF THE DRAWINGS

FIG. 1 is a block diagram schematically illustrating a configuration of a virtualized monitoring system;

FIG. 2 is a diagram expressing a database structure of the virtualized monitoring system illustrated in FIG. 1 through REST-API;

FIG. 3 is a block diagram illustrating a configuration of a virtual resource tracer of a virtualized monitoring system according to a first embodiment of the present invention;

FIG. 4 is a block diagram illustrating a configuration of a virtualized monitoring system according to a second embodiment of the present invention; and

FIG. 5 is a diagram illustrating a process of distributed processing of calculation in accordance with a script applied by a user according to the second embodiment.

### DETAILED DESCRIPTION OF THE PREFERRED EMBODIMENTS

Hereinafter, embodiments of the present invention will be described with reference to the accompanying drawings.

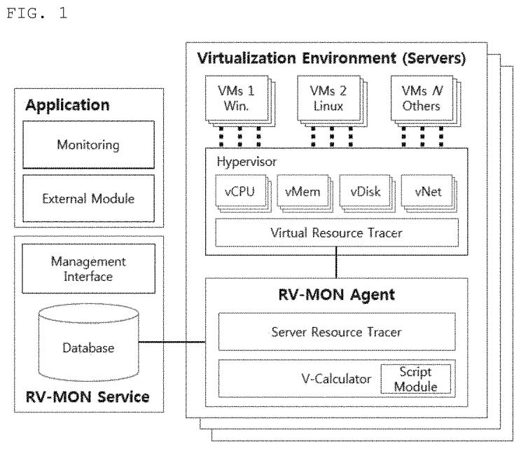

FIG. 1 is a block diagram schematically illustrating a configuration of a virtualized monitoring system.

The virtualized monitoring system (RV-MON) includes an RV-MON agent which collects resource information of a plurality of virtualization servers and a plurality of virtual machines, and an RV-MON service unit which integrates, stores, and aligns the information, and provides the information to an external module.

RV-MON Agent

The RV-MON agent resides on the virtualization server and can collect various and detailed resource information of a single server and a virtual machine (VM) to reduce resources consumed for monitoring. In addition, the RV-MON agent transmits all information of the virtualization servers configured with clusters to the RV-MON service unit to be integrated and stored in a database.

Differently from the existing monitoring tool, the RV-MON agent does not reside on a virtual machine which is a collection target, is driven by a single process in the virtualization server, and uses a hypervisor to collect information of the virtual machine in a server level. Accordingly, it is possible to collect resource information of the virtualization environment with a minimal specification.

As illustrated in FIG. 1, the RV-MON agent includes tracers which collect resource information, and a V-calculator which calculates a real-time resource usage rate on the basis of the collected information. The tracers are classified into a virtual resource tracer which collects resource information of a virtual machine, and a server resource tracer which collects resource information of a server.

The virtual resource tracer collects resource information of a virtual machine. In the process in which data of the virtual machine is transmitted to a kernel of a server through a hypervisor, the virtual resource tracer collects real-time resource information of the virtual machine by using an API provided by the hypervisor itself. As the information collected by the virtual resource tracer, there are a name and a universally unique identifier (UUID) of a virtual machine, basic information (options) of a system installed in the virtual machine, currently allocated resource specifications, and detailed parameters of a CPU (vCPU), a memory (vMem), a disk (vDisk), and a network (vNet). Among them, the name and UUID of the virtual machine and the basic information of the system installed in the virtual machine are collected only in a booting process of the virtual machine, and the currently allocated resource specifications and the detailed parameters of the CPU, the memory, the disk, and the network are collected in real time considering that a dynamic resource management method will change specifications in real time.

The RV-MON agent calculates a real-time resource usage on the basis of the information of the virtual machines collected as described above, transmits the real-time resource usage to the RV-MON service unit together with the detailed parameters, and stores in a database.

The server resource tracer collects system information of the server, and detailed resource parameters (CPU (vCPU), memory (vMem), disk (vDisk), and network (vNet)). The system information of the server is collected on the basis of information displayed on a Proc file system, and it is possible to obtain a real-time resource usage rate through this.

The V-calculator is operated in a distributed processing structure from the point of view of an overall structure of the RV-MON. The existing monitoring has a structure in which a central server processes all calculations, data collected by systems are stored in an integrated space, and a result processed on the basis of the information is provided. On the other hand, in the RV-MON agent, the information collected by a server is processed by the server, and a result thereof is integrated and stored in a database managed by the RV-MON service unit. The information basically (automatically) processed in the V-calculator is a real-time resource usage rate, and the resource usage rate is calculated by using detailed parameters of resources. The detailed parameters of resources are CPU capacity, memory capacity, disk capacity and bandwidth, and network bandwidth which are essential for driving a computer. The V-calculator can basically, and in addition, in accordance with user's demand, additionally process information including a resource usage rate. In this case, when a user writes a script of a calculation method for a specific parameter and submits the script to the RV-MON, each server calculates the script on the basis of the information of the server and the virtual machine and transmits a result thereof to the RV-MON service unit.

RV-MON Service Unit

The RV-MON service unit includes, to integrate and store information in a virtualization environment configured with clusters, a management interface which manages a database and an RV-MON agent, and the database which integrates and stores information collected bar the RV-MON agent.

The management interface allows a monitoring manager to set an information collection period and a storage pattern to solve a problem that the user has to arrange information whenever the information is provided when non-unified information is stored in the database because the virtualization environment configured with clusters has time periods different from each other for various reasons such as system load. Items provided by the management interface are 1) checking a state of the RV-MON agent and changing settings, 2) a calculation script to be applied to the V-calculator, and 3) management of a database.

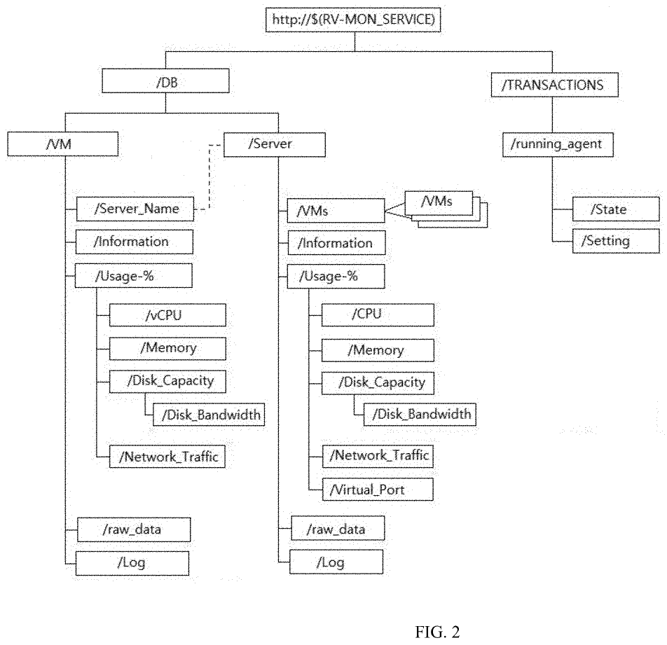

Since the database cumulatively stores information collected in real time by the monitoring system (RV-MON) and displays the information by time, a time-series database specialized, in flow of time is more suitable than a relational database which displays relationship among data. Input and output of the database are performed through REST-API, and an integrated database structure represented by the REST-API is as illustrated in FIG. 2.

The first layer illustrated in FIG. 2 is divided into /DB which represents input and output of a database and /TRANSACTION for setting an RV-MON agent. Data stored in the database is divided into data for a virtual machine (/VM) and data for a server (/Server). The data for a virtual machine has a structure of a server (/Server_Name) to which itself belongs, basic information (/Information), a past resource usage rate (/Usage-%), a resource parameter (/raw_data), and a log (/Log). The data for a server has the same structure as that of the virtual machine with respect to information other than virtual machines (/VMs) which belongs to itself. The /TRANSACTION representing the RV-MON agent has a structure supporting state information (/State) and setting (/Setting) of an agent.

The virtualized resource monitoring system according to a first embodiment of the present invention based on the virtualized resource monitoring system as described above simultaneously collects system log in addition to detailed resource parameter information collected by a virtual resource tracer and a server resource tracer and a resource usage rate calculated by a V-calculator on the basis thereof. The system log is important information to easily determine a problem of a system and is data necessary to analyze a resource usage. In the present invention, system log of the server and log of the virtual machine are collected. The system log of the virtualization server uses syslog of Linux, the log of the virtual machine uses log of QEMU and Libvirt, facility and severity of each logging system are designated to the maximum level to collect all log outputs, and they are processed into a raw-data file which is unstructured data and stored in a database together with the resource information.

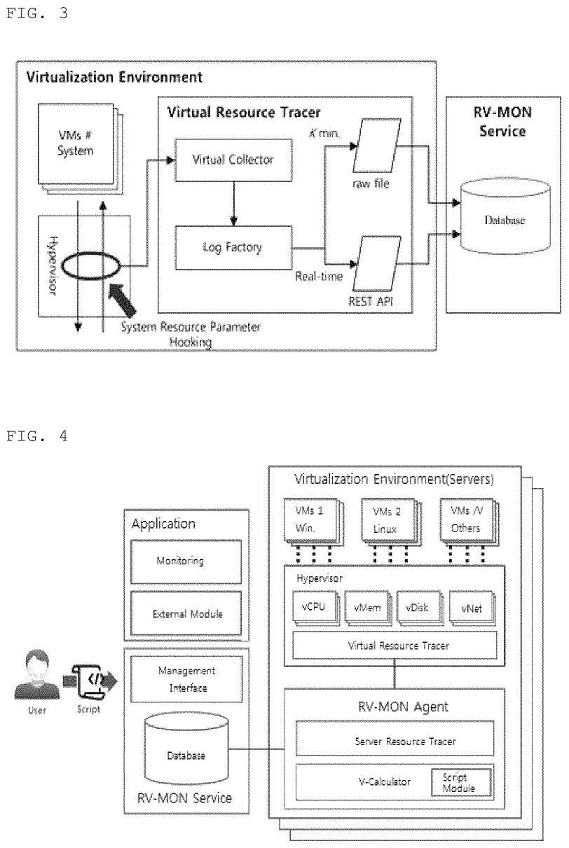

FIG. 3 is a block diagram illustrating a virtual resource tracer of the virtualized monitoring system according to the first embodiment of the present invention.

The virtual resource tracer includes a virtual collector and a log factory, and the server resource tracer has the same configuration.

The virtual collector extracts a trace process of a hypervisor in a code level and collects log. The log factory classifies the log collected by the virtual collector according to rating, arranges the log by time and calculation routine, generates a raw data file, and transmits a specific load (string) to the RV-MON service unit together with the collected resource information through REST-API when there is a user's request.

As described above, the virtualized monitoring system according to the first embodiment of the present invention stores the raw data generated from the log factory in the integrated database managed by the RV-MON service unit together with the collected resource information, and the integrated database manages the log in a file format and provides the log to a user through an interface. Since the user cannot directly handle an extraction routine for safety in security of a virtual machine, a resource usage rate is accurately predicted by analyzing detailed parameters of resources and system log recording problems of a system, thereby efficiently managing resources.

A virtualized resource monitoring system according to a second embodiment of the present invention performs distributed processing of information required by a user on the basis of resource information and system log collected by the tracer according to the first embodiment of the present invention.

The collected detailed parameters may be processed into various kinds of information, and representatively, the parameters may be expressed into a real-time resource usage. In a normal cluster environment, all data are stored in an integrated database, the collected detailed parameters are first stored in the database and then is read. In case of calculation, input and output loads of the database are increased, In addition, when all virtualization data configured with clusters are calculated in one place, the load of the system will be further increased. Accordingly, when the collected data is processed in the corresponding RV-MON agent, it is possible to reduce a load of the RV-MON service unit, input and output loads of the database are reduced, and a separate system is not necessary.

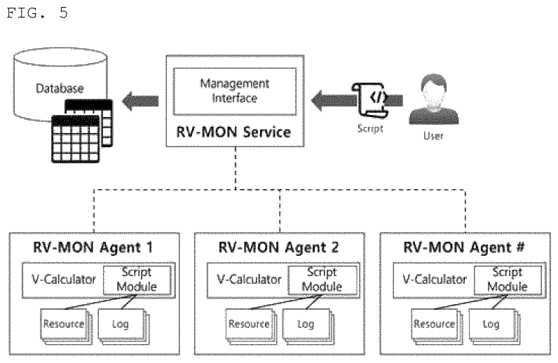

FIG. 4 is a block diagram illustrating the virtualized monitoring system according to the second embodiment of the present invention, to which a script module processing resource parameters into information is added to the configuration of the virtualized monitoring system according to the first embodiment of the present invention, FIG. 5 is a diagram exemplarily illustrating distributed processing of calculation in accordance with a script applied by a user according to the second embodiment of the present invention, and a method thereof is as follows.

First, a user submits a script to execute calculation through a management interface. The management interface checks a user script, advises a user to correct an error when there is an error, uploads the user script on a script module of the RV-MON agent when there is no error, and generates a table of an integrated database on the basis of the content of the uploaded script. The script module recognizes the uploaded script and applies the script to a calculation process of a V-calculator, the V-calculator executes user calculation on the basis of the resource information collected from the tracer on the basis of the applied script and transmits a calculation result to an RV-MON service unit together with detailed resource parameter information collected by a virtual resource tracer and a server resource tracer, and the user can check the result of the script applied by himself or herself in the integrated database.

As described above, the virtualized monitoring system according to the second embodiment of the present invention distributes calculation by using a part of strong resource performance of the virtualization server, thereby reducing a load of the central system. Accordingly, it is possible to construct the system with low costs. In addition, since the virtualized monitoring system executes a calculation process on the basis of data which the agent has before storing in the database, only one storing is performed. Therefore, it is possible to reduce excessive load of the database.

The virtualized resource monitoring system according to the present invention integrates and collects resource information and log in a virtualization environment to provide various and detailed information and can minimize resources consumed for monitoring through integrated management of virtual machines having various operating system environments. In addition, it is possible to process (calculate) additional information required by a user in the monitoring system without a separate system.

The above description is just an exemplary description of the technical spirit of the present invention, and a person skilled in the art can variously change and modify the embodiments within the scope which does not deviate from essential characteristics of the present invention. Accordingly, the embodiments described in the present invention do not limit but are to explain the technical spirit of the present invention, and the scope of the technical spirit of the present invention is not limited by such embodiments. The protection scope of the present invention has to be interpreted by the following Claims, and it should be interpreted that all the technical spirits within the scope equivalent thereto are included in the scope of rights of the present invention.

What is claimed is:

1. A virtualized resource monitoring system (RV-MON) comprising:
an RV-MON agent which collects resource information of a plurality of virtualization servers and a plurality of virtual machines through a hypervisor; and
an RV-MON service unit which integrates, stores, and aligns the resource information, and provides the resource information to an external module,
wherein the RV-MON agent includes
a virtual resource tracer which collects resource information of virtual machines,
a server resource tracer which collects resource information of virtualization servers, and
a V-calculator which calculates a resource usage rate on the basis of the information collected from the virtual machines and the virtualization servers,
wherein the RV-MON service unit includes
a database which integrates and stores the information collected in the RV-MON agent, and a management interface which manages the database and the RV-MON agent, and
wherein the management interface executes checking a state of the RV-MON agent and changing settings, a calculation script to be applied to the V-calculator, and management of a database table according to a virtualized server resource information and virtual machine resource information collection period and a storage pattern set from a monitoring unit.

2. The virtualized resource monitoring system (RV-MON) according to claim 1, wherein the collected resource information of the virtual machines includes
a name of a virtual machine,
a universally unique identifier (UUID),
basic information (options) of a system installed in a virtual machine,
currently allocated resource specifications,
detailed parameters of a CPU (vCPU), a memory (vMem), a disk (vDisk), and a network (vNet), and
system log.

3. The virtualized resource monitoring system (RV-MON) according to claim 1, wherein the collected resource information of virtualization servers includes
system information of a virtualization server,
detailed parameters of a CPU (vCPU), a memory (vMem), a disk (vDisk), and a network (vNet), and
system log.

4. The virtualized resource monitoring system (RV-MON) according to claim 1, wherein the resource usage rate is distributed and calculated in. real time or on user's demand with respect to one or more of CPU capacity, memory capacity, disk capacity, disk bandwidth, and network bandwidth.

5. The virtualized resource monitoring system (RV-MON) according to claim 1, wherein each of the virtual resource tracer and the server resource tracer includes
a virtual collector which extracts a trace process of the hypervisor in a code level and collects log, and
a log factory which classifies the collected log according to rating, arranges the log by time and calculation routine, generates a raw data file, and stores the raw data file in the database together with the collected resource information.

6. The virtualized resource monitoring system (RV-MON) according to Claim 1, further comprising a script module which receives a user script from the management interface and applies the user script to the calculation process of the V-calculator.
